(19) United States
(12) Patent Application Publication
(10) Pub. No.: US 2005/0116684 A1
(43) Pub. Date: Jun. 2, 2005

(54) Portable charger for mobile phones

(76) Inventor: Ju-young Kim, Seoul (KR)

Correspondence Address: HARNESS, DICKEY & PIERCE, P.L.C., P.O. BOX 828, BLOOMFIELD HILLS, MI, 48303, US

(21) Appl. No.: 10/824,334

(22) Filed: Apr. 14, 2004

(30) Foreign Application Priority Data
Nov. 27, 2003 (KR) 20-2003-37078
Feb. 12, 2004 (KR) 20-2004-3577

(51) Int. Cl. H02J 7/00

(52) U.S. Cl. 320/114

(57) ABSTRACT

An object of this invention is to provide a portable charger for a mobile phone. The portable charger includes a main body, a rechargeable battery, an accessory unit, and an earphone unit. The main body has a cradle on a predetermined portion thereof so that the mobile phone is seated in the cradle. The rechargeable battery is provided in the main body to be charged by electric power supplied to the portable charger. The accessory unit supports the main body in such a way that a user carries the portable charger. The earphone unit is provided to be drawn out from the main body. The portable charger is constructed to allow a user to carry, thus being available regardless of time and place. Further, the portable charger has a rechargeable battery therein, thus allowing a mobile phone to be charged without the supply of electric power, and allowing a user to make a call and listen to music using the audio function of the mobile phone even when the mobile phone is being charged.

### BACKGROUND OF THE INVENTION

1. Field of the Invention

The present invention relates generally to portable chargers for mobile phones, and more particularly to a portable charger for a mobile phone, which has a rechargeable battery therein, thus being easy to carry, in addition to charging the mobile phone.

2. Description of the Related Art

There have been known various kinds of chargers for mobile phones, for example, a stand-type charger and a jack-type charger. In this case, the stand-type charger is constructed such that a mobile phone is directly seated in the charger. Meanwhile, the jack-type charger is constructed to be connected a power terminal of the mobile phone, thus charging a rechargeable battery incorporated in the mobile phone.

The stand-type charger or the jack-type charger, which may be offered as options when purchasing a mobile phone, is used to charge the mobile phone. However, the stand-type charger or the jack-type charger has a problem in that it is difficult to carry, because the charger is usually placed on an item, such as a desk, or is installed at a supermarket or a charging station.

Of course, because the jack-type charger is small in volume, a user can carry the jack-type charger. However, the jack-type charger has a problem in that the charger must be connected to an outlet of a building, such as a house or an office, so as to supply electric power of 110 or 220 voltage to the jack-type charger.

Further, when a mobile phone is being charged using the conventional chargers, it is impossible to make a call with the mobile phone or listen to music using an audio function of the mobile phone.

Therefore, there is a growing demand on a charger for mobile phones, which is easy to carry, thus being available regardless of time and place, and which has a rechargeable battery in the charger, thus allowing a mobile phone to be charged without supplying electric power, and allowing a user to make a call and listen to music using the audio function of the mobile phone even when the mobile phone is being charged.

Further, the inventor of this invention proposed a portable charger for mobile phones, which may be offered in place of the stand-type charger or the jack-type charger that have been typically offered as the option when purchasing a mobile phone, or may be separately purchased, thus being convenient to use regardless of time and place.

### SUMMARY OF THE INVENTION

Accordingly, the present invention has been made keeping in mind the above problems occurring in the prior art, and an object of the present invention is to provide a portable charger for mobile phones, which has a rechargeable battery in the charger, thus allowing a mobile phone to be charged without requiring a connection between the charger and an electric power source.

Another object of the present invention is to provide a portable charger for mobile phones, which has an earphone in the charger, thus allowing a user to make a call or listen to music even when the mobile phone is being charged.

A further object of the present invention is to provide a portable charger for mobile phones, which is constructed such that an earphone wire of the earphone returns to an original length thereof when the earphone wire is released or a button is pressed after the earphone wire is drawn out from a main body to a desired length, thus being convenient to store the earphone in the charger.

A still another object of the present invention is to provide a portable charger for mobile phones, which may be offered in place of a stand-type charger or a jack-type charger that are offered as an option when purchasing a mobile phone, or may be separately purchased, thus being convenient to use regardless of time and place.

In order to accomplish the above object, the present invention provides a portable charger for a mobile phone, including a main body having a cradle on a predetermined portion thereof so that the mobile phone is seated in the cradle, a rechargeable battery provided in the main body to be charged by electric power supplied to the portable charger, an accessory unit to support the main body in such a way that a user carries the portable charger, and an earphone unit provided to be drawn out from the main body.

The accessory unit includes at least one of a clamp provided at a predetermined portion of the main body to clamp the main body on a user's belt, a neck-strap coupled to the main body to allow the main body to be worn around a user's neck, and a mount unit detachably mounted to a predetermined position of a vehicle.

The earphone unit includes a rotating shaft which is provided in the main body, an earphone wire which is wound around the rotating shaft and is drawn out through a first hole formed on a sidewall of the main body so as to be extended to a desired length, and an elastic member which restores the extended earphone wire to an original state thereof by an elastic force of the elastic member.

The earphone unit further includes a stopper unit which is operated to stop the earphone wire when the earphone wire is drawn out from the main body to the desired length and then is released. The stopper unit is operated to make the earphone wire be wound around the rotating shaft by the elastic member.

The stopper unit includes a plate spring cap which houses and support the elastic member therein and rotates along with the rotating shaft of the earphone unit, with a plurality of notches being formed around an outer circumferential surface of the plate spring cap to be spaced apart from each other, a rotary pin, and a stop lever rotating about the rotary pin in a see-saw manner, with a first end of the stop lever engaging with one of the notches of the plate spring cap to prevent the plate spring cap from being undesirably rotated, and a second end of the stop lever being exposed to an outside of the main body through a second hole formed on the sidewall of the main body.

The second end of the stop lever is exposed to the outside of the main body through the second hole of the main body, thus forming a button which is operated to disengage the first end of the stop lever from the associated notch.

The portable charger further includes a support pin which elastically biases a side of the stop lever, thus preventing the first end of the stop lever from being undesirably removed from the associated notch.

The earphone unit includes an earphone wire which is drawn out from the main body to a predetermined length, and a wire winding unit which temporarily stops the earphone wire when the earphone wire is drawn out from the main body to a desired length. The wire winding unit allows the earphone wire to be retracted into the main body when the earphone wire is further drawn in a same direction and then is released.

The wire winding unit includes a shaft, a bobbin, a guide disc, a return spring, a ball, and a ball moving disc part. The shaft is provided in the main body. The earphone wire is wound around the bobbin, and the bobbin rotates about the shaft and is stopped by a predetermined frictional resistance. The guide disc moves along with the bobbin and selectively compresses the bobbin so that the predetermined frictional resistance occurs between the bobbin and the guide disc. The return spring returns the bobbin to an original position thereof. The ball moves along a guide path formed on the guide disc. The ball moving disc part is provided to face the guide disc so that the ball is placed between the guide disc and the ball moving disc part, and supports the ball and forms a path of the ball's movement based on a position of the earphone wire extended from the main body.

The ball moving disc part is integrally provided on an inner surface of the front cover to be depressed.

The ball moving disc part includes a plurality of ball seats in which the ball is seated according to the position of the earphone wire extended from the main body. At least one of the ball seats is provided to have a depth which is different from remaining ball seats.

The guide path of the guide disc includes a reciprocating section where the ball reciprocates, and an arc-shaped moving section extending from a first side to a second side of the reciprocating section, so that the ball moves along the arc-shaped moving section. An inclined step is formed at each of both ends of the arc-shaped moving section adjacent to the reciprocating section to guide the ball from the reciprocating section to the arc-shaped moving section according to the position of the earphone wire extended from the main body.

The portable charger further includes upper and lower caps mounted to the front and rear covers, respectively, thus preventing the rotation of the shaft of the wire winding unit. Each of the upper and lower caps includes a fitting projection fitted into a slit which is cut on each of upper and lower ends of the shaft of the wire winding unit to have a desired length, and a locking projection to lock each of the upper and lower caps to the corresponding front and rear covers.

The return spring comprises a spiral spring seated in a spring seat which is provided in the bobbin, with a first end of the return spring being supported by the slit which is provided on the upper end of the shaft of the wire winding unit, and a second end of the return spring being supported by the bobbin.

The cradle supports upper and lower ends of the mobile phone or both side surfaces of the mobile phone.

The cradle supports both side surfaces of the mobile phone, and the mobile phone is magnetically attached to and removed from a phone seating surface of the cradle.

The portable charger further includes a metal pad attached to a surface of the mobile phone, and at least one magnet provided on the phone seating surface so that the metal pad of the mobile phone is magnetically attached to the magnet.

The phone seating surface further includes a magnet support member which supports the magnet, a magnet cover which is placed on the magnet support member and has at least one magnet seating holes to seat the magnet therein, and a fastening member which fastens the magnet cover and the magnet support member to the phone seating surface.

The portable charger further includes an ornament pad which is made of a material to pass a magnetic force therethrough, and is attached to the magnet cover.

The portable charger further includes a circuit board which has a power terminal and is connected to the rechargeable battery to supply the electric power to the rechargeable battery, and a radio local transceiver mounted to a predetermined portion of the circuit board.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a portable charger for mobile phones, according to a first embodiment of the present invention;

FIG. 2 is a plan view to show an interior of a rear cover included in the charger of FIG. 1;

FIG. 3 is a plan view to show an earphone unit and a stopper unit included in the charger of FIG. 1;

FIG. 4 is a schematic sectional view of the earphone unit of FIG. 3;

FIG. 5 is a perspective view of a portable charger for mobile phones, according to a second embodiment of the present invention;

FIG. 6 is a perspective view of a portable charger for mobile phones, according to a third embodiment of the present invention;

FIG. 7 is a perspective view of a portable charger for mobile phones, according to a fourth embodiment of the present invention;

FIG. 8 is an exploded perspective view to show a wire winding unit of the charger of FIG. 7;

FIGS. 9a and 9b are respectively plan views to show a guide disc and a rear surface of a front cover of the charger of FIG. 7; and

FIG. 10 is an exploded perspective view of a portable charger for mobile phones, according to a fifth embodiment of the present invention.

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

### First Embodiment

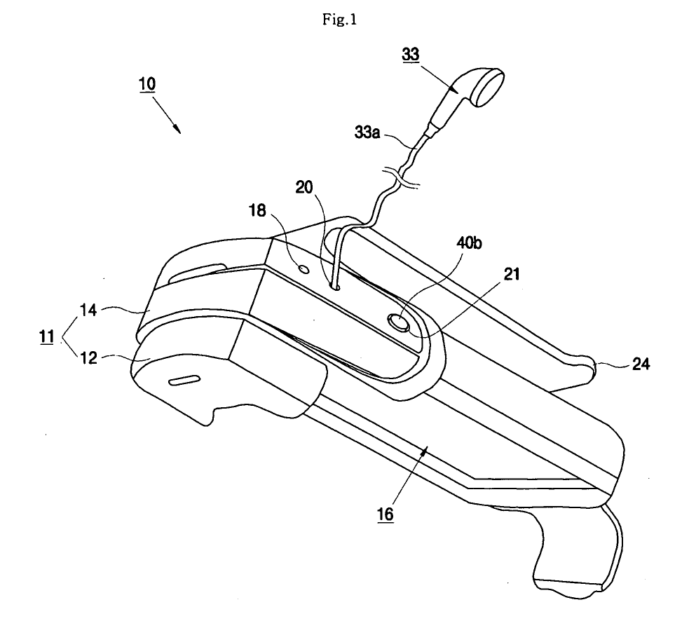

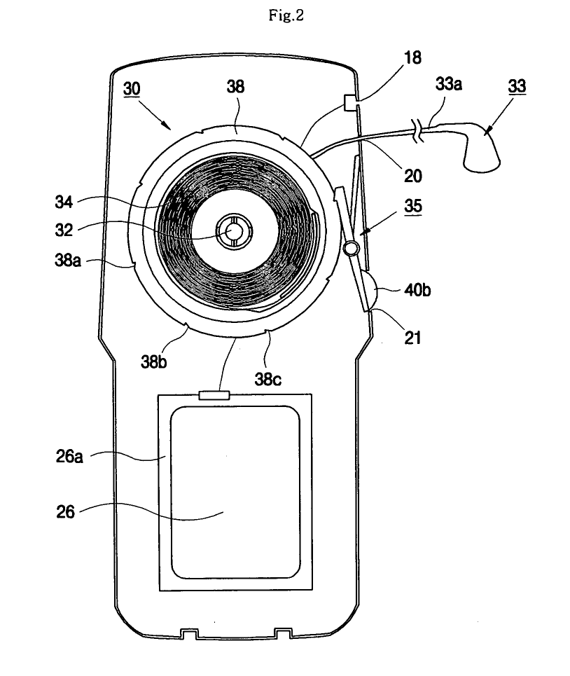

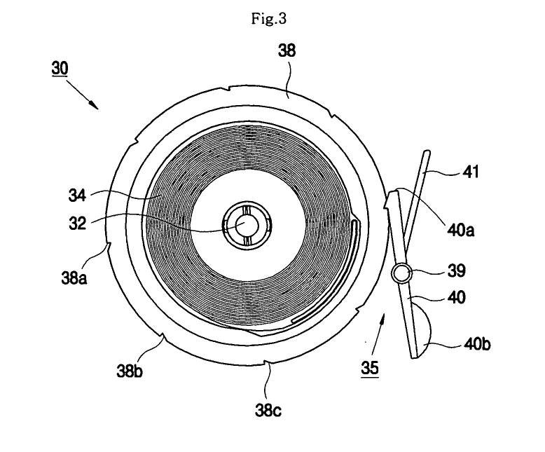

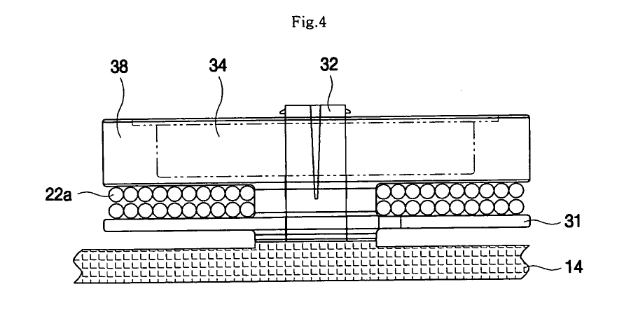

FIG. 1 is a perspective view of a portable charger for mobile phones, according to a first embodiment of the present invention, FIG. 2 is a plan view to show an interior of a rear cover included in the charger of FIG. 1, FIG. 3 is a plan view to show an earphone unit and a stopper unit included in the charger of FIG. 1, and FIG. 4 is a schematic sectional view of the earphone unit of FIG. 3.

As shown in FIG. 1, according to the first embodiment of the present invention, the portable charger 10 for mobile phones includes a main body 11 and an accessory unit. The main body 11 has a front cover 12 and a rear cover 14 that are separable from each other. The accessory unit supports the main body 11 in such a way that a user carries the charger 10. Further, a cradle 16 is provided on the front cover 12 so that a mobile phone is seated in the cradle 16.

First, second, and third holes 18, 20, and 21 are formed on a sidewall of the rear cover 14. A plug extending from the mobile phone is inserted into the first hole 18 to charge the mobile phone using a rechargeable battery 26 of the charger 10. An earphone wire 33a of an earphone 33 is drawn through the second hole 20 to an outside of the main body 11. Further, a button 40b which will be described later herein is provided in the third hole 21 to be exposed to the outside of the main body 11.

As an example of the accessory unit, a clamp 24 is provided on a rear surface of the rear cover 14 to clamp the charger 10 on a user's belt, thus allowing the user to conveniently carry the charger 10.

As shown in FIG. 2, the rechargeable battery 26, an earphone unit 30, and a stopper unit 35 are provided inside the rear cover 14.

The rechargeable battery 26 functions to charge the mobile phone seated in the cradle 16, and is connected to a circuit board 26a having a power terminal (not shown). When the charger 10 is not in use, it is necessary to connect an electric power source to the power terminal of the circuit board 26a through an electric wire so that the rechargeable battery 26 is charged by the circuit board 26a. Of course, it is preferable that the rechargeable battery 26 have a quick charging structure.

As shown in FIGS. 3 and 4, the earphone unit 30 includes a shaft support disc 31, a rotating shaft 32, the earphone wire 33a, and an elastic member. The shaft support disc 31 is mounted to a predetermined portion of the rear cover 14. The rotating shaft 32 is coupled to the shaft support disc 31. The earphone wire 33a is wound around the rotating shaft 32, and is drawn out from the main body 11 through the second hole 20 to be extended to a desired length. The extended earphone wire 33a returns to an original state by an elastic force of the elastic member.

According to the first embodiment, a plate spring 34 is used as the elastic member. The plate spring 34 is housed and supported in a plate spring cap 38 which will be described herein later. The plate spring 34 retains an elastic force by the rotation of the rotating shaft 32, and returns to the original state when an external force is eliminated.

The earphone unit 30 further includes the stopper unit 35. The stopper unit 35 functions to stop the earphone wire 33a when the earphone wire 33a is drawn out from the main body 11 to a desired length and then is released. Further, the stopper unit 35 is operated to make the earphone wire 33a be wound around the rotating shaft 32 by the plate spring 34.

The stopper unit 35 includes the plate spring cap 38, a rotary pin 39, and a stop lever 40. The plate spring cap 38 rotates along with the rotating shaft 32, with a plurality of notches 38a, 38b, and 38c being formed around an outer circumferential surface of the plate spring cap 38 to be spaced apart from each other. The stop lever 40 rotates about the rotary pin 39 in a see-saw manner. A first end 40a of the stop lever 40 engages with one of the notches 38a, 38b, and 38c of the plate spring cap 38 to prevent the plate spring cap 38 from being undesirably rotated, and a second end 40b of the stop lever 40 is exposed to an outside of the main body 11 through the third hole 21.

In this case, each of the notches 38a, 38b, and 38c has a triangular cross-section with a hooking surface, while the first end 40a of the stop lever 40 has a shape of a hook. Thus, as shown in FIG. 3, when the first end 40a of the stop lever 40 engages with one of the notches 38a, 38b, and 38c, the plate spring cap 38 can rotate clockwise but cannot rotate counterclockwise.

The second end 40b of the stop lever 40 forms the button which is exposed to the outside of the main body 11 through the third hole 21. Thus, when the button 40b is pressed, the stop lever 40 rotates about the rotary pin 39, and simultaneously the first end 40a of the stop lever 40 disengages from the associated notch 38a, 38b, 38c.

The stopper unit 35 further includes a support pin 41. The support pin 41 elastically biases a side of the stop lever 40 to prevent the first end 40a of the stop lever 40 from being undesirably removed from the associated notch 38a, 38b, 38c. In other words, the support pin 41 biases the first end 40a of the stop lever 40 to the plate spring cap 38.

The operation and operational effect of the portable charger 10 according to the first embodiment are as follows.

The mobile phone is seated in the cradle 16 of the charger 10 to be supported by the charger 10. Next, the plug (not shown) extending from the mobile phone is inserted into the first hole 18. Thus, while the mobile phone is being charged by the charger 10, a user can make a call. Further, when the mobile phone is seated in the charger 10, the user can carry the charger 10 on the user's belt using the clamp 24.

When the user desires to make a call or listen to music during the charge of the mobile phone, the user draws the earphone wire 33a exposed to an outside of the rear cover 14 through the second hole 20. At this time, the rotating shaft 32 installed in the rear cover 14 rotates, so that the length of the earphone wire 33a is further extended.

As the rotating shaft 32 rotates, the plate spring cap 38 and the plate spring 34 simultaneously rotate. Meanwhile, when the user stops drawing the earphone wire 33a, the rotating shaft 32 and the plate spring cap 38 rotate in the reverse direction by the restoring force or elastic force of the plate spring 34. During such rotations of the rotating shaft 32 and the plate spring cap 38, the first end 40a of the stop lever 40 engages with one of the notches 38a, 38b, and 38c of the plate spring cap 38. Thereby, the rotation of the plate spring cap 38 is ceased. Thus, it is possible to use a common function of the mobile phone while maintaining the length of the earphone wire 33a as desired.

When there is no necessity of using the earphone wire 33a after making a call or listening to music, the button 40b of the stop lever 40 exposed to the outside of the rear cover 14 through the third hole 21 is pressed. Then, the stop lever 40 rotates about the rotary pin 39 in the see-saw manner, so that the first end 40a of the stop lever 40 disengages from the associated notch 38a, 38b, 38c of the plate spring cap 38. Simultaneously, the rotating shaft 32 is rotated by the restoring force of the plate spring 34, so that the earphone wire 33a is wound around the rotating shaft 32, thus returning to the original state.

As such, according to the first embodiment, the portable charger is constructed to allow a user to carry, thus being available regardless of time and place. Further, the portable charger has the rechargeable battery 26 therein, thus being capable of charging the mobile phone without an additional supply of electric power. Furthermore, the portable charger allows the user to make a call or listen to music even when the mobile phone is being charged.

### Second Embodiment

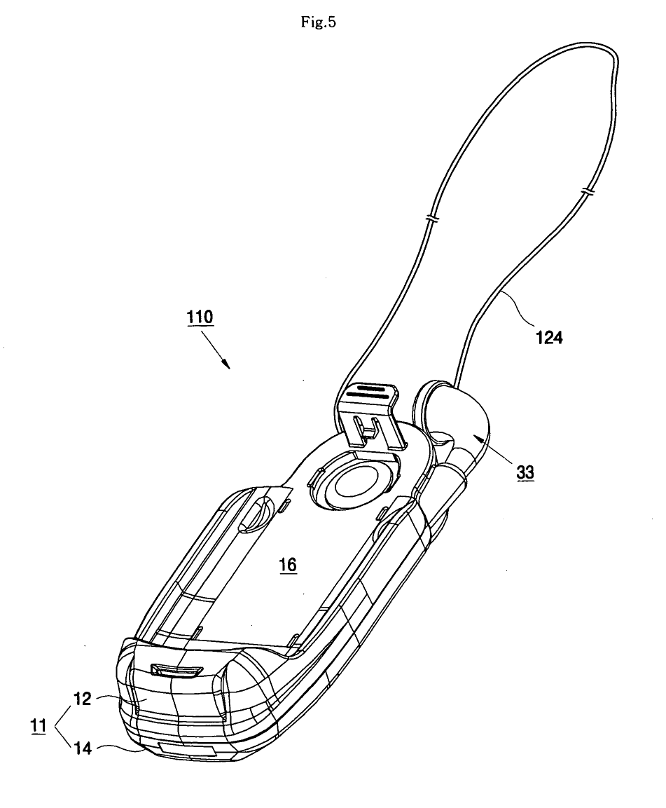

FIG. 5 is a perspective view of a portable charger for mobile phones, according to a second embodiment of the present invention. Referring to FIG. 5, the portable charger 110 has a neck-strap 124, as an example of the accessory unit. The neck-strap 124 is coupled to the main body 11 to allow the main body 11 to be worn around a user's neck. Of course, it is preferable that coupling rings (not shown) be provided at predetermined portions of the main body 11 so as to easily couple the neck-strap 124 to the main body 11.

According to the second embodiment, the user is capable of wearing the portable charger 110 around the user's neck using the neck-strap 124. In this case, the operational effects of the portable charger 110 according to the second embodiment remain the same as the portable charger 10 according to the first embodiment.

### Third Embodiment

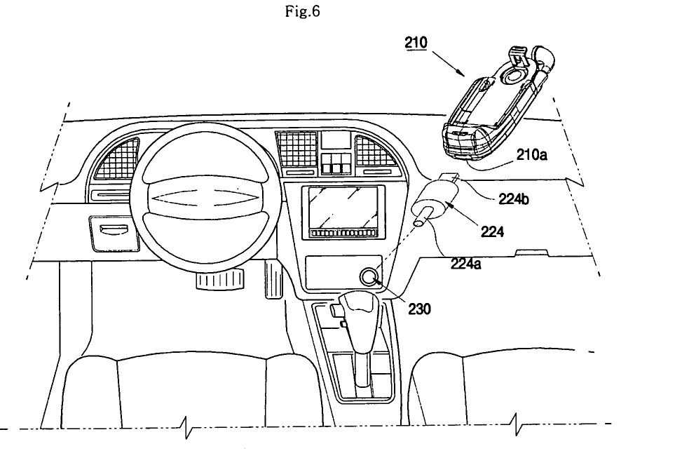

FIG. 6 is a perspective view of a portable charger for mobile phones, according to a third embodiment of the present invention. Referring to FIG. 6, the portable charger 210 is removably mounted to a predetermined position of a vehicle. In order to removably mount the charger 210 to the vehicle, a mount unit (not shown) may be provided at a predetermined portion of the charger 210.

However, in case where the portable charger 210 is not provided with the mount unit, as shown in FIG. 6, a connecting member 224 may be additionally provided to connect the charger 210 to a lighter jack 230 of the vehicle.

In this case, the connecting member 224 may have various shapes. However, in order to apply the connecting member 224 to a common jack-type charger, the connecting member 224 must have a simple structure, as shown in FIG. 6. That is, the connecting member 224 is constructed so that a first portion 224a thereof is inserted into the lighter jack 230 of the vehicle, while a second portion 224b thereof is inserted into a charging part 210a provided on a lower end of the charger 210.

Or, the connecting member 224 may be constructed such that the first portion 224a thereof is inserted into the lighter jack 230 of the vehicle, and the second portion 224b thereof has a shape of a conventional socket so that a plug of an extension cable which is connected to the charging part 210a provided on the lower end of the charger 210 can be inserted into the socket of the connecting member 224.

### Fourth Embodiment

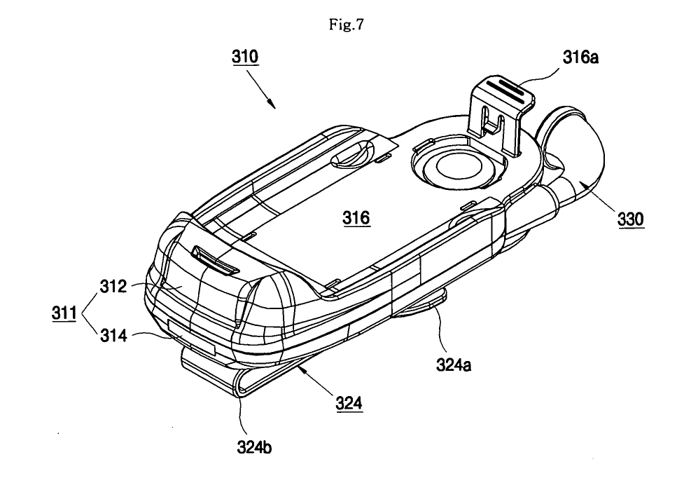

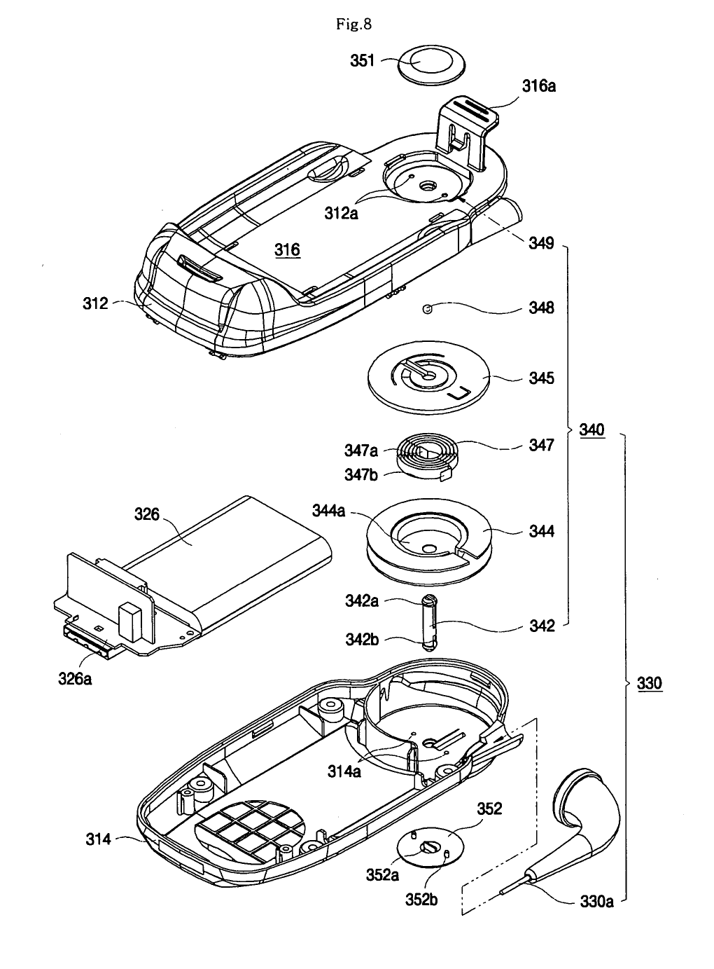

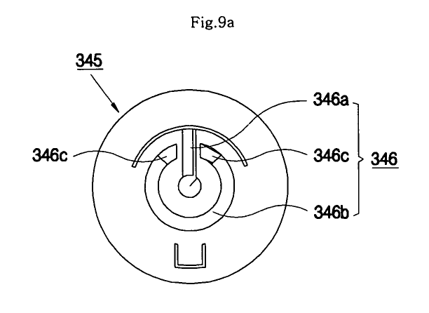

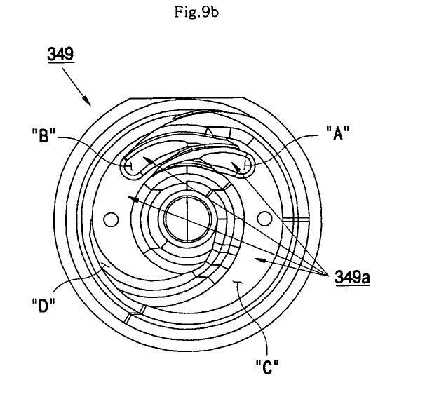

FIG. 7 is a perspective view of a portable charger for mobile phones, according to a fourth embodiment of the present invention, FIG. 8 is an exploded perspective view to show a wire winding unit of the charger of FIG. 7, and FIGS. 9a and 9b are respectively plan views to show a guide disc and a rear surface of a front cover of the charger of FIG. 7.

According to the fourth embodiment, the portable charger 310 includes a main body 311 and an accessory unit. The main body 311 has a front cover 312 and a rear cover 314 that are separable from each other. The accessory unit supports the main boy 311 to allow a user to carry the main body 311.

A cradle 316 is provided on the front cover 312 so that a mobile phone is seated in the cradle 316. A projecting terminal (not shown) is provided at a predetermined position of the cradle 316 to be inserted into a depressed terminal formed on a lower end of the mobile phone, and an elastic bar 316a is provided at a position of the cradle 316 opposite to the projecting terminal so as to prevent the mobile phone to be removed from the cradle 316.

As an example of the accessory unit, a clamp 324 which has a construction different from the clamp 24 of FIG. 1 is provided on a rear surface of the rear cover 314 to clamp the charger 310 on a desired item, such as the user's belt, thus allowing the user to carry the charger 310. The clamp 324 of the fourth embodiment is constructed as follows. That is, when a first portion 324a of the clamp 324 is pressed, a second portion 324b of the clamp 324 is elastically spaced apart from the rear cover 314. Conversely, when the first portion 324a is released, the second portion 324b comes into contact with the rear cover 314 again. Thus, such a clamp 324 allows the charger 310 to be easily held on a desired item, such as a belt.

A rechargeable battery 326 is provided inside the rear cover 314. As described above, the rechargeable battery 326 functions to charge the mobile phone, and is connected to a circuit board 326a having a power terminal (not shown).

When the charger 310 is not in use, an electric power source is connected to the power terminal of the circuit board 326a through a charging electric wire or an adapter (not shown) so that the rechargeable battery 326 is charged by the circuit board 326a.

In this case, a lead acid battery, a nickel cadmium battery, a nickel hydrogen battery, a lithium ion battery, a lithium polymer battery, and others may be used as the rechargeable battery 326. Of course, it is preferable that the rechargeable battery 326 have a quick charging structure, thus being more convenient to use the rechargeable battery 326.

According to the fourth embodiment, an earphone unit 330 includes an earphone wire 330a and a wire winding unit 340. The earphone wire 330a has at an end thereof an earpiece, and is drawn out from the main body 311 to a desired length. The earphone wire 330a is wound around a bobbin 344 which will be described hereinafter. In this case, the bobbin 344 is constructed to have an additional boss, so that the earphone wire 330a is wound around the additional boss as well as the web of the bobbin 344, and thus a desired length of the earphone wire 330a is secured.

When the earphone wire 330a is drawn out from the main body 311 to a desired length, the wire winding unit 340 functions to temporarily stop the extended earphone wire 330a at a predetermined position. Further, when the earphone wire 330a is released after being slightly drawn in the same direction, the earphone wire 330a returns to an interior of the main body 311 by the wire winding unit 340.

Such a wire winding unit 340 includes a shaft 342, the bobbin 344, a guide disc 345, a return spring 347, a ball 348, and a ball moving disc part 349. The shaft 342 is provided in the main body 311. The bobbin 344 around which the earphone wire 330a is wound rotates about the shaft 342, and is stopped by a predetermined frictional resistance. The guide disc 345 moves along with the bobbin 344 to selectively compress the bobbin 344 so that the predetermined frictional resistance occurs between the guide disc 345 and the bobbin 344. The return spring 347 functions to return the bobbin 344 to an original position thereof. The ball 348 moves along a guide path 346 formed in the guide disc 345. The ball moving disc part 349 is provided at a position to face the guide disc 345 so that the ball 348 is placed between the ball moving disc part 349 and the guide disc 345. The ball moving disc part 349 supports the ball 348, and forms a path of the ball's movement based on a position of the earphone wire 330a extended from the main body 311.

The ball moving disc part 349 compressing an upper portion of the ball 348 may be separately manufactured, and then assembled with other elements into a single structure. However, according to the fourth embodiment, the ball moving disc part 349 is integrally provided on an inner surface of the front cover 312 to be depressed.

As shown in FIGS. 9a and 9b, a plurality of ball seats 349a are provided in the ball moving disc part 349 so that the ball 348 is placed in the associated ball seat 349a according to the position of the earphone wire 330a extended from the main body 311. At least one of the ball seats 349a is provided to have a depth which is different from remaining ball seats 349a. When the ball 348 is placed in the ball seat 349a which has a shallow depth, the ball moving disc part 349 compresses the ball 348. Thereby, there occurs the frictional resistance between the guide disc 345 and the bobbin 344, so that the bobbin 344 is stopped and thereby the earphone wire 330a is stopped.

The ball 348 moves along the guide path 346 of the guide disc 345 as well as the ball seats 349a of the ball moving disc part 349. In this case, the guide path 346 includes a reciprocating section 346a where the ball 348 reciprocates, and an arc-shaped moving section 346b. The arc-shaped moving section 346b extends from a first side to a second side of the reciprocating section 346a, so that the ball 348 moves along the arc-shaped moving section 346b.

Further, an inclined step 346c is provided at each of both ends of the arc-shaped moving section 346b adjacent to the reciprocating section 346a to guide the ball 348 from the reciprocating section 346a to the arc-shaped moving section 346b according to the position of the earphone wire 330a extended from the main body 311.

Referring to FIGS. 9a and 9b, at first, the ball 348 is placed in a portion A of the ball seats 349a of the ball moving disc part 349. When the earphone wire 330a is drawn in such a state, the ball 348 moves to portions B, C, and D of the ball seats 349a. In this case, when the user stops drawing the earphone wire 330a, the ball 348 is placed in the portion B of the ball seats 349a. In this case, the portions A and B of the ball seats 349a are shallower than the remaining ball seats 349a, thus functioning to compressing the ball 348 toward the bobbin 344.

While the ball 348 moves along the ball seats 349a of the ball moving disc part 349, the ball 348 is placed in the reciprocating section 346a of the guide path 346, and then moves to the arc-shaped moving section 346b after passing through one of the inclined steps 346c.

Further, upper and lower caps 351 and 352 are provided on opposite ends of the wire winding unit 340 to close the opposite ends of the wire winding unit 340 and prevent movement of the shaft 342. The upper cap 351 includes a fitting projection (not shown) fitted into a slit 342a which is cut on an upper end of the shaft 342, and two locking projections (not shown) inserted into two locking holes 312a of the front cover 312, respectively. Similarly to the upper cap 351, the lower cap 352 includes a fitting projection 352a fitted into a slit 342b which is cut on a lower end of the shaft 342, and two locking projections 352b inserted into two locking holes 314a of the rear cover 314, respectively.

Thus, when the shaft 342 is placed at a predetermined position in the main body 311 and then the upper and lower caps 351 and 352 are respectively fastened to the upper and lower ends of the shaft 342 through the front and rear covers 312 and 314, the fitting projection (not shown) of the upper cap 351 and the fitting projection 352a of the lower cap 352 are respectively fitted into the slits 342a and 342b which are cut on the upper and lower ends of the shaft 342, thus preventing the shaft 342 from rotating.

A spring seat 344a is provided in the bobbin 344 which rotates when the earphone wire 330a is drawn or released, so that the return spring 347 is seated in the spring seat 344a. According to the fourth embodiment, the return spring 347 comprises a spiral spring. A first end 347a of the return spring 347 is supported by the slit 342a which is provided on the upper end of the shaft 342 passing through the bobbin 344, while a second end 347b of the return spring 347 is supported by the bobbin 344.

Thus, when the earphone wire 330a is drawn out from the main body 311, the return spring 347 is compressed. Thereafter, when the earphone wire 330a is released, the return spring 347 returns to an original state thereof, thus allowing the bobbin 344 to return to an original position thereof.

By such a construction, when the earphone wire 330a is drawn out from the main body 311, the ball 348 moves from the reciprocating section 346a of the guide path 346 of the guide disc 345 through one of the inclined steps 346c to the arc-shaped moving section 346b.

Simultaneously, the ball 348, which is placed in the portion A of the ball seats 349a at first, moves to the portions B, C, and D of the ball seats 349a by the rotating bobbin 344 and guide disc 345 until the user stops drawing the earphone wire 330a. At this time, the ball 348 is placed in the portion B which has a shallower depth.

Thus, the ball 348 placed in the portion B compresses the guide disc 345 and the bobbin 344, so that the frictional resistance occurs between the bobbin 344 and an inner surface of the rear cover 314. Due to the frictional resistance, the bobbin 344 is forcibly stopped. Since the rotation of the bobbin 344 is stopped, the earphone wire 330a is temporarily stopped at a desired length.

Meanwhile, when the earphone wire 330a is slightly drawn in the same direction and then is released, the ball 348 moves from the portion B to the portions C and D which are more deeply formed. At this time, the compressed return spring 347 returns to the original state thereof, so that the earphone wire 330a returns to the original position thereof in the main body 311.

### Fifth Embodiment

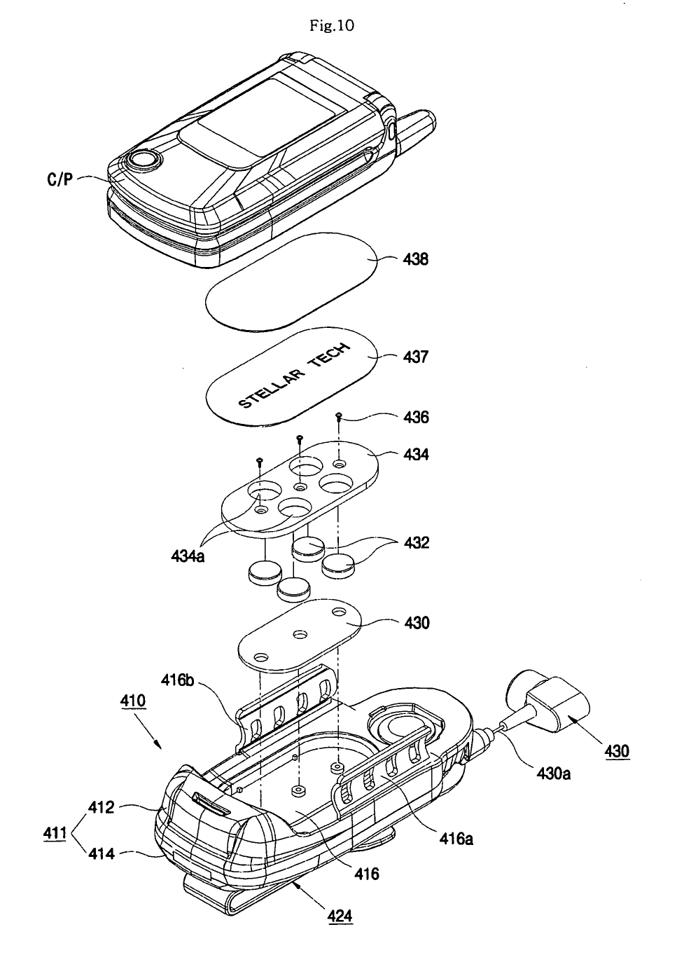

FIG. 10 is an exploded perspective view of a portable charger for mobile phones, according to a fifth embodiment of the present invention. The portable charger 410 of the fifth embodiment has a construction similar to the portable charger 310 of the fourth embodiment shown in FIG. 7.

As shown in FIG. 10, the portable charger 410 includes a main body 411 and an accessory unit. The main body 411 has a front cover 412 and a rear cover 414 that are separable from each other. An earphone 430 having an earphone wire 430a is retractably coupled to the main body 411. Further, as an example of the accessory unit, a clamp 424 is provided on the rear cover 414.

Meanwhile, the cradle 316 (see, FIG. 7) is constructed to support the upper and lower ends of a mobile phone C/P. However, in this case, different kinds of chargers must be required to charge different kinds of mobile phones.

In order to solve the problem, as shown in FIG. 10, the portable charger 410 is constructed such that the mobile phone C/P is seated in a phone seating surface 416 by a magnetic force while both side surfaces of the mobile phone C/P are supported by phone support walls 416a and 416b. Of course, in this case, the mobile phone C/P must be connected to the charger 410 via a connection line, so that charging power is supplied from the charger 410 to the mobile phone C/P. Because such a construction is known to those skilled in the art, the construction will not be described in detail herein.

A simple method of holding the mobile phone C/P using a magnetic force is as follows. That is, a metal pad 438 is attached to a rear surface of the mobile phone C/P, and a plurality of magnets 432 are provided on the phone seating surface 416 to be in magnetic contact with the metal pad 438 of the mobile phone C/P.

As shown in FIG. 10, the portable charger 410 may further include a magnet support member 430, a magnet cover 434, and a plurality of fastening members 436. The magnet support member 430 supports the magnets 432. The magnet cover 434 is placed on the magnet support member 430, and a plurality of magnet seating holes 434a are provided on the magnet cover 434 so that the magnets 432 are seated in the corresponding magnet seating holes 434a. The magnet cover 434 and the magnet support member 430 are integrally fastened to the phone seating surface 416 by the fastening members 436.

Further, an ornament pad 437 which is made of a material to pass a magnetic force therethrough may be attached to the magnet cover 434 so that the charger 410 has a good appearance and advertising effects. Of course, a name of a charger manufacturing company may be provided on the ornament pad 437.

When the above-mentioned elements are sequentially mounted to the phone seating surface 416 as shown in FIG. 10, thus producing the portable charger 410, the portable charger 410 is capable of compatibly charging various kinds of mobile phones.

The present invention is described herein with reference to the above embodiments, but this invention is not limited to the embodiment.

In the above-mentioned embodiments, the plate spring is used as an elastic member. But, a coil spring, an elastic cord, and others may be used as the elastic member without being limited to the plate spring. Further, the construction of the earphone unit may be changed according to the kind of the elastic member.

Further, according to the embodiments, the earphone unit, the stopper unit, and the first, second, and third holes are provided at the rear cover. But, the above-mentioned elements may be provided at the front cover or provided at predetermined positions of an interior of the main body.

Further, according to the embodiments, a user uses the function of the mobile phone using the earphone wire. However, it is possible to use the function of the mobile phone by a wireless earphone communicating with a radio local transceiver, for example, a radio module having bluetooth chips. It is preferable that the radio module be mounted to a circuit board. But, the radio module may be installed at a position other than the circuit board.

According to the above embodiment, a metal pad is attached to a rear surface of a mobile phone. However, it is unnecessary to attach the metal pad to the mobile phone, if the mobile phone is made of a metal which is attracted by a magnet.

As described above, the present invention provides a portable charger for mobile phones, which has a rechargeable battery in the charger, thus allowing a mobile phone to be charged without the necessity of connecting the charger to an electric power source.

Further, a portable charger for mobile phones has an earphone therein, thus allowing a user to make a call or listen to music even when the mobile phone is being charged.

According to the present invention, a portable charger for mobile phones is constructed such that an earphone wire of the earphone returns to an original length thereof when the earphone wire is released or a button is pressed after the earphone wire is drawn out from a main body to a desired length, thus being convenient to store the earphone in the charger.

Further, a portable charger for mobile phones may be offered in place of a stand-type charger or a jack-type charger that are offered as an option when purchasing a mobile phone, or may be separately purchased, thus being convenient to use regardless of time and place.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The entire disclosure of Korean Patent Application No. 2003-37078 filed Nov. 27, 2003 and Korean Patent Application No. 2004-3577 filed Feb. 12, 2004 are hereby incorporated by reference.

1. A portable charger for a mobile phone, comprising:
a main body having a cradle on a predetermined portion thereof so that the mobile phone is seated in the cradle;
a rechargeable battery provided in the main body to be charged by electric power supplied to the portable charger;
an accessory unit to support the main body in such a way that a user carries the portable charger; and
an earphone unit provided to be drawn out from the main body.

2. The portable charger according to claim 1, wherein the accessory unit comprises at least one of a clamp provided at a predetermined portion of the main body to clamp the main body on a user's belt, a neck-strap coupled to the main body to allow the main body to be worn around a user's neck, and a mount unit detachably mounted to a predetermined position of a vehicle.

3. The portable charger according to claim 1, wherein the earphone unit comprises:
a rotating shaft provided in the main body;
an earphone wire wound around the rotating shaft, the earphone wire being drawn out through a first hole formed on a sidewall of the main body so as to be extended to a desired length; and
an elastic member to restore the extended earphone wire to an original state thereof by an elastic force of the elastic member.

4. The portable charger according to claim 3, wherein the earphone unit further comprises:
a stopper unit operated to stop the earphone wire when the earphone wire is drawn out from the main body to the desired length and then is released, the stopper unit being operated to make the earphone wire be wound around the rotating shaft by the elastic member.

5. The portable charger according to claim 4, wherein the stopper unit comprises:
a plate spring cap to house and support the elastic member therein and rotate along with the rotating shaft of the earphone unit, with a plurality of notches being formed around an outer circumferential surface of the plate spring cap to be spaced apart from each other;
a rotary pin; and
a stop lever rotating about the rotary pin in a see-saw manner, with a first end of the stop lever engaging with one of the notches of the plate spring cap to prevent the plate spring cap from being undesirably rotated, and a second end of the stop lever being exposed to an outside of the main body through a second hole formed on the sidewall of the main body.

6. The portable charger according to claim 5, wherein the second end of the stop lever is exposed to the outside of the main body through the second hole of the main body, thus forming a button which is operated to disengage the first end of the stop lever from the associated notch.

7. The portable charger according to claim 5 or 6, further comprising:
a support pin to elastically bias a side of the stop lever, thus preventing the first end of the stop lever from being undesirably removed from the associated notch.

8. The portable charger according to claim 1, wherein the earphone unit comprises:
an earphone wire drawn out from the main body to a predetermined length; and
a wire winding unit to temporarily stop the earphone wire when the earphone wire is drawn out from the main body to a desired length, the wire winding unit allowing the earphone wire to be retracted into the main body when the earphone wire is further drawn in a same direction and then is released.

9. The portable charger according to claim 8, wherein the wire winding unit comprises:
a shaft provided in the main body;
a bobbin around which the earphone wire is wound, the bobbin rotating about the shaft and being stopped by a predetermined frictional resistance;
a guide disc moving along with the bobbin and selectively compressing the bobbin so that the predetermined frictional resistance occurs between the bobbin and the guide disc;
a return spring to return the bobbin to an original position thereof;
a ball to move along a guide path formed on the guide disc; and
a ball moving disc part provided to face the guide disc so that the ball is placed between the guide disc and the ball moving disc part, the ball moving disc part supporting the ball and forming a path of a movement of the ball based on a position of the earphone wire extended from the main body.

10. The portable charger according to claim 9, wherein the ball moving disc part is integrally provided on an inner surface of the front cover to be depressed.

11. The portable charger according to claim 10, wherein the ball moving disc part comprises a plurality of ball seats in which the ball is seated according to the position of the earphone wire extended from the main body, at least one of the ball seats being provided to have a depth which is different from remaining ball seats.

12. The portable charger according to claim 9, wherein the guide path of the guide disc comprises:
a reciprocating section where the ball reciprocates; and
an arc-shaped moving section extending from a first side to a second side of the reciprocating section, so that the ball moves along the arc-shaped moving section, with an inclined step being formed at each of both ends of the arc-shaped moving section adjacent to the reciprocating section to guide the ball from the reciprocating section to the arc-shaped moving section according to the position of the earphone wire extended from the main body.

13. The portable charger according to claim 9, further comprising:
upper and lower caps mounted to the front and rear covers, respectively, thus preventing the rotation of the shaft of the wire winding unit, each of the upper and lower caps comprising:
a fitting projection fitted into a slit which is cut on each of upper and lower ends of the shaft of the wire winding unit to have a desired length; and
a locking projection to lock each of the upper and lower caps to the corresponding front and rear covers.

14. The portable charger according to claim 13, wherein
the return spring comprises a spiral spring seated in a spring seat which is provided in the bobbin, with a first end of the return spring being supported by the slit which is provided on the upper end of the shaft of the wire winding unit, and a second end of the return spring being supported by the bobbin.

15. The portable charger according to claim 1, wherein the cradle supports upper and lower ends of the mobile phone or both side surfaces of the mobile phone.

16. The portable charger according to claim 15, wherein the cradle supports both side surfaces of the mobile phone, and the mobile phone is magnetically attached to and removed from a phone seating surface of the cradle.

17. The portable charger according to claim 16, further comprising:
a metal pad attached to a surface of the mobile phone; and
at least one magnet provided on the phone seating surface so that the metal pad of the mobile phone is magnetically attached to the magnet.

18. The portable charger according to claim 17, wherein the phone seating surface further comprises:
a magnet support member to support the magnet;
a magnet cover placed on the magnet support member, and having at least one magnet seating holes to seat the magnet therein; and
a fastening member to fasten the magnet cover and the magnet support member to the phone seating surface.

19. The portable charger according to claim 18, further comprising:
an ornament pad made of a material to pass a magnetic force therethrough, and attached to the magnet cover.

20. The portable charger according to claim 1, further comprising:
a circuit board having a power terminal, the circuit board being connected to the rechargeable battery to supply the electric power to the rechargeable battery; and
a radio local transceiver mounted to a predetermined portion of the circuit board.
